(19) United States
(12) Patent Application Publication
(10) Pub. No.: US 2014/0011079 A1
(43) Pub. Date: Jan. 9, 2014

(54) BATTERY TERMINAL TOOL

(71) Applicant: Bradley W. Davidson, Mission, KS (US)

(72) Inventor: Bradley W. Davidson, Mission, KS (US)

(21) Appl. No.: 13/935,143

(22) Filed: Jul. 3, 2013

Related U.S. Application Data
(60) Provisional application No. 61/667,743, filed on Jul. 3, 2012.

(51) Int. Cl. H01M 2/30; H01M 2/02; B25B 15/00

(52) U.S. Cl. CPC H01M 2/30; B25B 15/001; H01M 2/022
USPC 429/178

(57) ABSTRACT

The present invention includes a portable battery with a shaped positive terminal that may be used as a tool for engaging a battery door fastener. The terminal protrudes from the positive end of the battery similar to a traditional cap and base battery terminal. The shape allows the positive terminal to engage with a battery door fastener and, when the battery is rotated, drive the fastener into either an open or closed position. This allows the battery door to be locked or unlocked without the hassle of locating a separate tool such as a screwdriver. To replace a battery, a person uses the replacement battery to disengage the battery door fastener, opens the battery door, replaces the used battery, then closes the door and reengages the fastener with the used battery. The shaped terminal may also serve as a three dimensional identifier for which end of the battery is the positive terminal.

### CROSS-REFERENCE TO RELATED APPLICATIONS

This application claims the benefit of co-pending application Ser. No. 61/667,743, filed on Jul. 3, 2012, entitled BATTERY TERMINAL TOOL.

### FIELD

The present invention generally relates to batteries used to provide electricity to electrically powered portable devices such as consumer electronics, toys, tools, and emergency equipment, and more particularly, to a battery with a shaped terminal configured to engage a complimentary fastener.

### BACKGROUND

Portable batteries are generally used to provide electrical energy to electrically-powered devices that are not capable of receiving electrical power from a permanent source such as an electrical wall receptacle. Portable batteries are generally either disposable (often referred to as primary cell) or rechargeable (often referred to as secondary cell). The structure of a portable battery generally consists of an anode, a cathode, electrolyte, and a negative and a positive terminal. Electrical energy is produced due to a chemical reaction occurring inside the battery. The device being powered by the battery receives the electrical energy by making contact with the negative and positive terminals simultaneously.

Batteries are usually installed in a dedicated battery compartment in or on the device it is powering. This compartment is usually enclosed and the compartment cover, or door, is usually secured in place by screws or other type of fastener. This covered compartment serves a few purposes. First, it ensures the battery stays in place and properly connected while providing power to the device. Second, it retains the battery so that the battery does not fall out and become lost while the device is being moved. Third, the cover protects a person holding the device from being exposed to the hazards of an exposed battery. Such hazards include electrical shock, toxic material leaking out of the battery, or even the risk of choking in the case of an infant.

The deficiency of the conventional battery and compartment arrangement mentioned above is that a separate tool (such as a screw driver, or coin) is often required to open the compartment door to service the battery. Having to find and use a separate tool to open the compartment door can be inconvenient and frustrating. In the event a tool cannot be found to open the compartment cover, servicing the battery may be difficult. The present invention solves the problem of having to use a separate tool for opening the battery compartment door because the battery itself serves as the tool.

### SUMMARY

The present invention comprises a shaped positive terminal for a portable battery. This shaped terminal provides two benefits over traditional battery terminals. First, due to the terminal's shape, the battery can be mated to the head of a battery compartment door fastener and used as a tool to lock or unlock the door. The shaped terminal is located on the positive end of the battery and protrudes above the planar surface of the end (similar to a round positive terminal on a traditional cap and base battery). The terminal is shaped to match a complementarily-shaped recess on the head of a battery door fastener. When the terminal is seated in the head's recess and the battery is rotated about its longitudinal axis, the terminal will apply torque to the fastener thus causing the fastener to rotate. The rotating of the fastener will cause the compartment door to lock or unlock as desired.

A second benefit of the shaped terminal is that it serves to identify which end of the battery is the positive end. This identification benefit can be realized regardless of whether the battery is used as a tool for the battery door fastener. By making the positive terminal in the shape of a cross or plus sign, or other shapes, one will immediately be aware that the terminal is the battery's positive terminal. This may be particularly useful for individuals with poor or no eyesight that would otherwise have difficulty seeing the positive terminal designation printed on the exterior of the battery. Knowing which end of the battery is positive is critical to using the battery. Batteries must be installed in the exact orientation prescribed by the manufacturer of the device being powered. If a battery is installed such that the positive and negative terminals are reversed from locations specified by the manufacturer, the device may be damaged and/or will not operate.

### BRIEF DESCRIPTION OF THE DRAWINGS

FIG. 1 is a side view of a traditional D-size cap and base battery.

FIG. 2 is a top view of the battery in FIG. 1.

FIG. 3 is a side view of a traditional C-size cap and base battery.

FIG. 4 is a top view of the battery in FIG. 3.

FIG. 5 is a side view of a traditional AA-size cap and base battery.

FIG. 6 is a top view of the battery in FIG. 5.

FIG. 7 is a side view of a traditional AAA-size cap and base battery

FIG. 8 is a top view of the battery in FIG. 7.

FIG. 9 is a perspective view of a cap and base battery with a cross-shaped positive terminal.

FIG. 10 is a side view of a D-size cap and base battery with a cross-shaped positive terminal.

FIG. 11 is a top view of the battery in FIG. 10.

FIG. 12 is a side view of a C-size cap and base battery with a cross-shaped positive terminal.

FIG. 13 is a top view of the battery in FIG. 12.

FIG. 14 is a side view of a AA-size cap and base battery with a cross-shaped positive terminal.

FIG. 15 is a top view of the battery in FIG. 14.

FIG. 16 is a side view of a AAA-size cap and base battery with a cross-shaped positive terminal.

FIG. 17 is a top view of the battery in FIG. 16.

FIG. 18 is a side view of a fastener with head recess sized to receive the cross-shaped positive terminal shown in FIG. 11.

FIG. 19 is a top view of the fastener in FIG. 18.

FIG. 20 is a side view of a fastener with head recess sized to receive the cross-shaped positive terminal shown in FIG. 13.

FIG. 21 is a top view of the fastener in FIG. 20.

FIG. 22 is a side view of a fastener with head recess sized to receive the cross-shaped positive terminal shown in FIG. 15.

FIG. 23 is a top view of the fastener in FIG. 22.

FIG. 24 is a side view of a fastener with head recess sized to receive the cross-shaped positive terminal shown in FIG. 17.

FIG. 25 is a top view of the fastener in FIG. 24.

FIG. 26 is a top view of another embodiment of the battery of the present invention with a square-shaped positive terminal.

FIG. 27 is a perspective view of the battery of FIG. 26.

FIG. 28 is a top view of a fastener with a head recess configured to receive the square-shaped positive terminal shown in FIG. 26.

FIG. 29 is a side view of the fastener of FIG. 28.

FIG. 30 is a top view of another embodiment of the battery of the present invention with a triangle-shaped positive terminal.

FIG. 31 is a perspective view of the battery of FIG. 30.

FIG. 32 is a top view of a fastener with a head recess configured to receive the triangle-shaped positive terminal shown in FIG. 30.

FIG. 33 is a side view of the fastener of FIG. 32.

FIG. 34 is a top view of another embodiment of the battery of the present invention with a spline-shaped positive terminal.

FIG. 35 is a perspective view of the battery of FIG. 34.

FIG. 36 is a top view of a fastener with a head recess configured to receive the spline-shaped positive terminal shown in FIG. 34.

FIG. 37 is a side view of the fastener of FIG. 36.

FIG. 38 is a top view of another embodiment of the battery of the present invention with an oval-shaped positive terminal.

FIG. 39 is a perspective view of the battery of FIG. 38.

FIG. 40 is a top view of a fastener with a head recess configured to receive the oval-shaped positive terminal shown in FIG. 38.

FIG. 41 is a side view of the fastener of FIG. 40.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

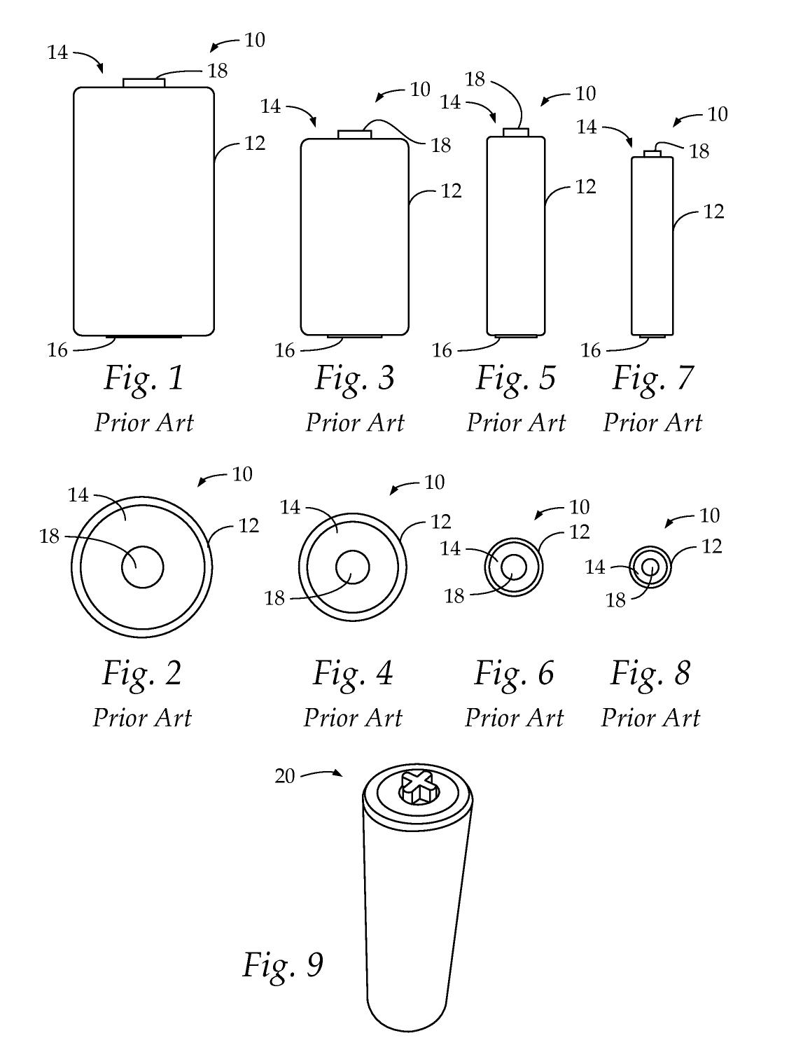

Referring to the drawings in more detail, FIGS. 1 through 8 depict traditional cap and base batteries sized D through AAA indicated by reference numeral 10, which serve as the technology being improved upon. Each of the prior art batteries includes a cylindrical body 12, a positive cap 14 and a negative cap 16. The body 12 is electrically insulated from the positive cap 14 and negative cap 16. The positive cap 14 includes a cylindrical positive terminal 18 extending from the positive cap 14. Terminal 18 protrudes a short distance from cap 14. The protrusion of terminal 18 is raised to improve the likelihood that the terminal will make adequate contact with the device that the battery is powering. Likewise, the negative cap 16 is a generally flat cylindrical surface and protrudes slightly from the body for the same reason of improving the likelihood of adequate contact with the device being powered. The specific dimensions of the batteries in FIGS. 1-8 are based on standards set forth by the American National Standards Institute (“ANSI”). The ANSI standard relevant to the portable batteries in this patent is ANSI C18.1M, Part 1-2009.

Referring to FIGS. 9-17, a battery 20 of the present invention with the similar size and shape of the prior art batteries in FIGS. 1-8, includes a positive terminal 22 in place of the traditional cylindrical terminal 18. Like terminal 18, positive terminal 22 protrudes a short distance from the positive cap 24 to improve contact with the device being powered. The height of terminal 22 may be the same or differ from the height of terminal 18 because terminal 22 may extend sufficiently from positive cap 24 to engage the recess of a battery door fastener (see FIGS. 19-24) when the battery 20 is used as a tool for driving the fastener. The other features of the battery are the same as the traditional batteries in FIGS. 1-8.

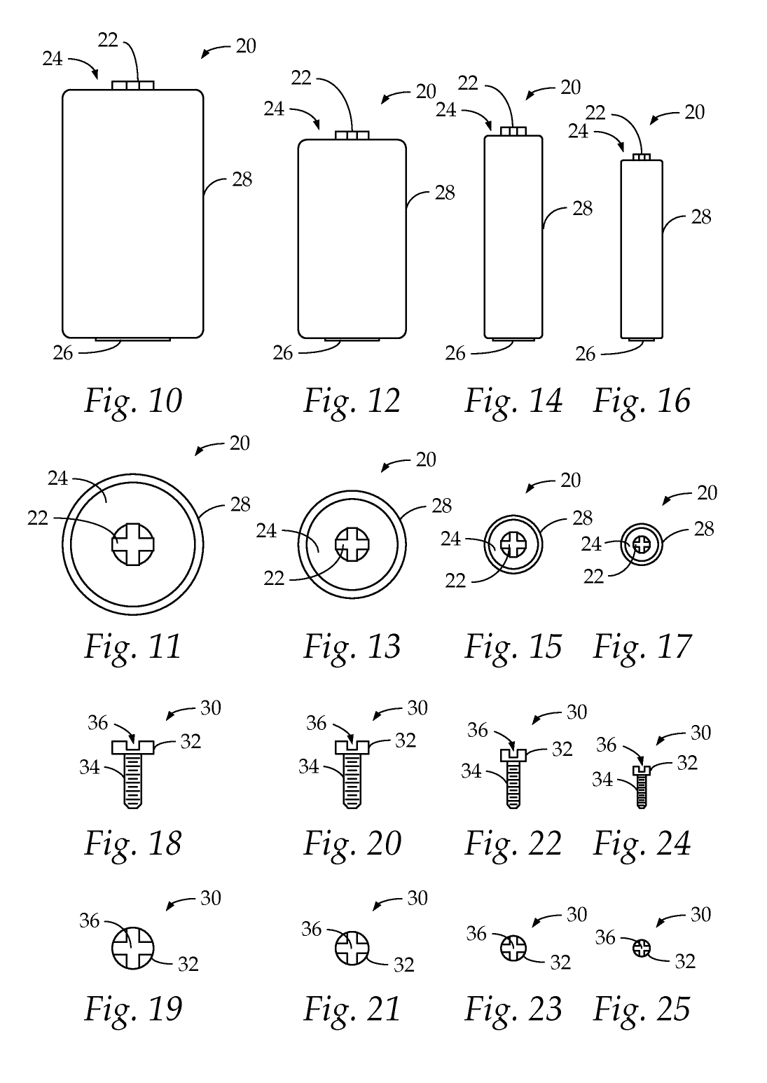

FIGS. 10-17 depict cap and base batteries sized D through AAA that include the positive terminal 22 extending from positive cap 24 in place of the traditional cylindrical terminal 18. The battery 20 is the same size and shape as the prior art batteries in FIGS. 1-8, and also include a negative cap 26 and a cylindrical body 28 electrically insulated from positive cap 24 and negative cap 26.

The positive terminal 22 is in the shape of a plus sign to clearly designate the positive terminal of the battery. The positive terminal 22 also serves as a tool to loosen and tighten a complementary fastener disclosed hereinbelow.

Referring to FIGS. 18-25, battery door fasteners 30 configured to receive the positive terminals 22 are illustrated. Each fastener includes a head 32 and a threaded shaft 34. The fastener head 32 has a recess or channel 36 that is generally the same shape as that of the respective positive terminal 22, which would drive the fastener 30. Recess 36 will be slightly larger in size than the positive terminal 22 so that terminal 22 can easily be inserted into the recess 36. When the battery 20 is rotated about its longitudinal axis, the positive terminal 22 engages the recess 36 to rotate the screw 30. FIGS. 19, 21, 23 and 25 are top views of the screws depicted in FIGS. 18, 20, 22, and 24, respectively, and illustrate that the screws in this fastener embodiment comprise circular heads. It is foreseen that the battery door fasteners used in this invention may not be limited to screws and may be any number of fasteners capable of securing a battery door in a closed position.

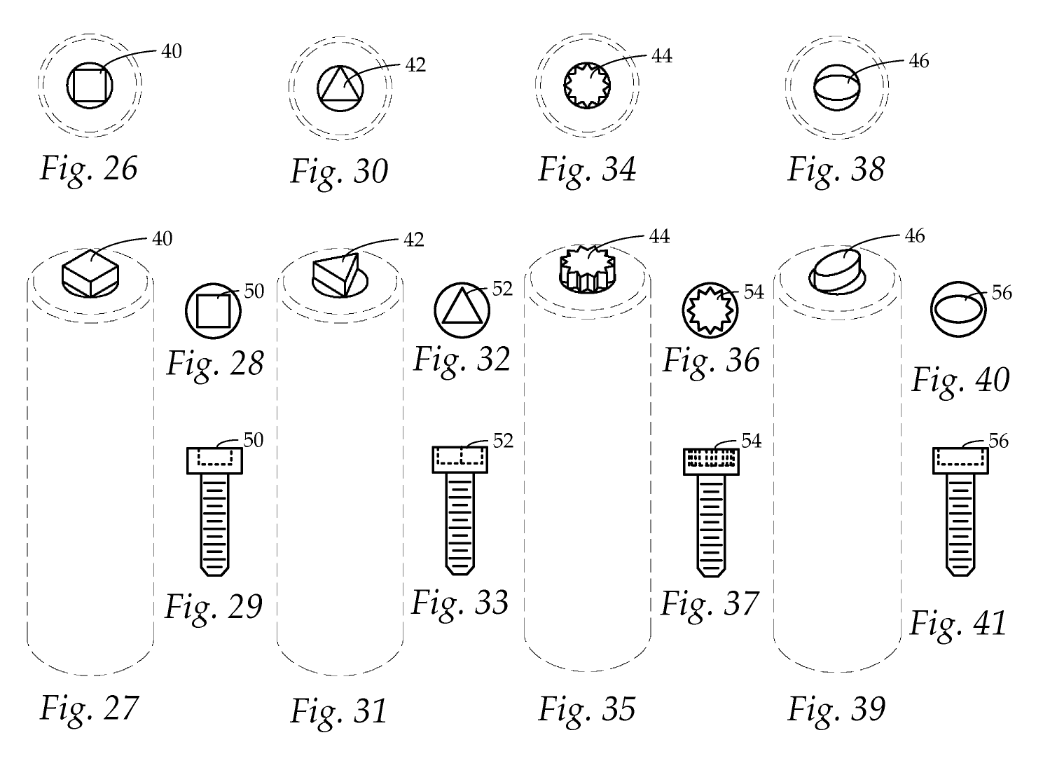

Referring to FIGS. 26-41, other positive terminal shapes may be used such as a square 40, a triangle 42, a spline 44, an oval 46, a torx or hex (not shown), for example, with fasteners 50, 52, 54 and 56 having complementary heads, respectively. The shapes shown are exemplary only and not limiting. Other shapes may be used.

In use, when the batteries of a battery-powered device are exhausted, a battery of the present invention may be used to loosen the fastener of the battery door by engaging the shaped positive terminal with the fastener head. Using the battery as a tool, the fastener is turned until the battery door may be opened, and the exhausted batteries replaced with new batteries. An exhausted battery may then be used to tighten the fastener. Additionally, for positive terminals in the shape of a plus sign, square, triangle, torx, oval, or other shape, the positive terminal may readily be identified for proper installation in the battery-powered device.

It is to be understood that while certain forms of the present invention have been illustrated and described herein, it is not to be limited to the specific forms or arrangement of the parts described and shown.

Having thus described the invention, what is claimed as new and desired to be secured by Letters Patent is as follows:

1. A battery comprising:
a body having a positive terminal protruding from a first end of said body and a negative terminal protruding from a second end of said body opposite said first end of said body,
said positive terminal having a non-cylindrical shape.

2. The battery of claim 1 further comprising in combination a fastener having a head having a complimentary shape to said non-cylindrical shape of said positive terminal and configured to receive said positive terminal.

3. The battery of claim 1 wherein said positive terminal is a cross shape.

4. The battery of claim 3 further comprising in combination a fastener having a head having a complimentary shape to said cross shape of said positive terminal and configured to receive said positive terminal.

5. The battery of claim 1 wherein said positive terminal is a square shape.

6. The battery of claim 5 further comprising in combination a fastener having a head having a complimentary shape to said square shape of said positive terminal and configured to receive said positive terminal.

7. The battery of claim 1 wherein said positive terminal is a triangle shape.

8. The battery of claim 7 further comprising in combination a fastener having a head having a complimentary shape to said triangle shape of said positive terminal and configured to receive said positive terminal.

9. The battery of claim 1 wherein said positive terminal is a spline shape.

10. The battery of claim 9 further comprising in combination a fastener having a head having a complimentary shape to said spline shape of said positive terminal and configured to receive said positive terminal.

11. The battery of claim 1 wherein said positive terminal is an oval shape.

12. The battery of claim 11 further comprising in combination a fastener having a head having a complimentary shape to said oval shape of said positive terminal and configured to receive said positive terminal.

13. The battery of claim 1 wherein said positive terminal is a hex shape.

14. The battery of claim 13 further comprising in combination a fastener having a head having a complimentary shape to said hex shape of said positive terminal and configured to receive said positive terminal.

15. The battery of claim 1 wherein said positive terminal is a torx shape.

16. The battery of claim 15 further comprising in combination a fastener having a head having a complimentary shape to said torx shape of said positive terminal and configured to receive said positive terminal.

17. A battery comprising:
a cylindrical body having a positive terminal protruding from a first end of said cylindrical body and a negative terminal protruding from a second end of said cylindrical body opposite said first end of said cylindrical body,
said negative terminal having a cylindrical shape,
said positive terminal having a non-cylindrical shape.

18. The battery of claim 17 wherein said positive terminal has a shape selected from the group consisting of a square, triangle, spline, oval, hex, and torx.

19. A battery comprising:
a cylindrical body having a positive terminal protruding from a first end of said cylindrical body and a negative terminal protruding from a second end of said cylindrical body opposite said first end of said cylindrical body,
said negative terminal having a raised cylindrical shape,
said positive terminal having a non-cylindrical shape selected from the group consisting of a square, triangle, spline, oval, hex, and torx.
